(19) United States
(12) Patent Application Publication
(10) Pub. No.: US 2014/0258167 A1
(43) Pub. Date: Sep. 11, 2014

(54) DELIVERY OF POSTAL ITEMS BY PARTICIPANTS OF A DELIVERY SERVICE

(71) Applicant: DEUTSCHE POST AG, Bonn (DE)

(72) Inventors: Manuela Rohmann, Bonn (DE); Georg Schlaghecken, Bonn (DE); Martin Wegner, Meckenheim (DE); Jorg Hanser, Bonn (DE)

(21) Appl. No.: 14/350,663

(22) PCT Filed: Oct. 11, 2012
(86) PCT No.: PCT/EP2012/070102

§ 371 Date: Apr. 9, 2014

(30) Foreign Application Priority Data
Oct. 11, 2011 (DE) 102011084282.9

(51) Int. Cl. G06Q 10/08

(52) U.S. Cl. CPC G06Q 10/08345
USPC 705/335

(57) ABSTRACT

The invention relates to a method for delivering a mailpiece to a destination address, whereby the mailpiece is held at one depot of a plurality of depots. With the method, (i) a first participant of a service is selected from a plurality of participants registered for the service on the basis of an association of the participant with that depot, (ii) a request is sent to the selected first participant and an acceptance message sent by the participant in response to the request is received, and (iii) the mailpiece is handed over to the first participant at the depot on the basis of the receipt of the acceptance message for the transport over at least a partial segment of a delivery route to the destination address.

### Related Application

This application filed under 35 U.S.0 §371 is a national phase application of International Application Ser. No. PCT/EP2012/070102 filed Oct. 11, 2012, which claims priority to German Patent Application No. DE 102011084282.9, filed on Oct. 11, 2011, the disclosure of which is entirely incorporated herein by reference.

### TECHNICAL FIELD

The invention relates to the transport of mailpieces such as letters and/or parcels to a destination address. In particular, the invention relates to a method and to a system for transporting a mailpiece.

### BACKGROUND ART

In order to deliver mailpieces, delivery companies generally use a logistics network with an infrastructure comprising mail distribution centers which are located in various regions of the delivery area and to which the mailpieces to be delivered in the regions are transported within the logistics network. At the distribution centers, the mailpieces are picked up by carriers, or else the carriers take over the mailpieces at delivery depots of the delivery company, which are each associated with a distribution center and to which the mailpieces are transported from the distribution center in an intermediate step. The carriers transport the mailpieces within the regions to their recipients. The segment of the delivery routes of mailpieces serviced by the carriers is also referred to as the “last mile”.

Each carrier delivers a number of mailpieces on a delivery route within a certain district. Particularly when the mail volume is low, relatively large distances over the delivery routes are covered between the individual recipient addresses that are serviced by a carrier. This can be disproportionately time-consuming for the carrier. If the carrier is using a motorized delivery vehicle, which is generally the case for the delivery of parcels, then large distances between the recipient addresses can also translate into disproportionately high costs for the operation of the vehicle and to disproportionately high emissions from the vehicle.

### DISCLOSURE OF THE INVENTION

Therefore, before this backdrop, an objective of the present invention is to permit an alternative delivery of mailpieces on the last mile that can be carried out so as to use fewer resources than the conventional delivery by specific carriers, whereby the price for the delivery should be freely negotiable within predefined limits between the recipient and a carrier.

This objective is achieved by a method according to claim 1 and by a system according to claim 14. Embodiments of the method and of the system are put forward in the dependent claims.

According to one aspect of the invention, a method for delivering a mailpiece to a destination address is being proposed, whereby the mailpiece is held at one depot of a plurality of depots. Moreover, with the method, at least one first participant of a service is selected from a plurality of participants registered for the service on the basis of an association of the participant with that depot, whereby the recipient of the mailpiece uses a communication terminal device to indicate a price he is willing to pay for the delivery, and whereby this price and a request are transmitted to the at least one selected first participant of the service and an acceptance message sent by the participant in response to the request is received. Moreover, the mailpiece is handed over to the first participant at the depot on the basis of the receipt of the acceptance message for the transport over at least a partial segment of a delivery route to the destination address.

According to another aspect, the invention proposes a system for transporting a mailpiece to a destination address, comprising at least one depot of a plurality of depots for holding mailpieces, and comprising a server. The server is configured to select at least one first participant of a service from a plurality of participants registered for the service on the basis of an association of the participant with a depot, to send a request to the selected first participant and to receive an acceptance message from the participant that is sent in response to the request, whereby the mailpiece can be handed over to the first participant on the basis of the receipt of the acceptance message for the transport over at least a partial segment of a delivery route to the destination address.

The method and the system make it possible for participants of a delivery service to deliver a mailpiece. By responding to an appertaining request message, these participants can indicate their willingness to take over the transport of the mailpiece, at least over a partial segment of a delivery route, for an offered price. As a result, no special carriers have to be used for the delivery of the mailpiece, so that the delivery can be carried out with fewer resources. In particular, the participants of the delivery service can carry the mailpiece with them on routes that they have to travel anyway. In this case, the resource savings are especially high since there is no need to employ additional resources for the delivery of mailpieces on the last mile from the depot to the destination address of the mailpiece.

One embodiment of the method and of the system provides that, in each case, a route is stored for each of the participants of the service and the at least one first participant is selected on the basis of an evaluation of the stored routes of the participants, whereby the evaluation is carried out as a function of the location of the depot and/or of the destination address of the mailpiece. The route, which is preferably stored in the server, can be a route that is traveled by the participants one time or regularly, for example, every day or every workday. In the latter case, the routes can be, for instance, the workday routes traveled by the participants on their way to their workplaces.

The participants of the delivery service to whom the mailpiece is handed over at the depot can transport the mailpiece all the way to its destination address. By the same token, the possibility exists that the participant does not transport the mailpiece along its entire route all the way to the destination address. Therefore, one embodiment of the method and of the system entails that, on the basis of the routes stored for the participants, at least one additional participant is selected to transport the mailpiece over another partial segment of the delivery route, and that a transfer point for handing over the mailpiece to the additional participant is determined. In this manner, the delivery route can advantageously be divided into several partial segments on which the mailpiece is transported by one participant each time. The transfer points are preferably points at which the routes of the participants intersect or at least approach each other to within a predefined maximum distance. The depots can be any establishments at which mailpieces can be dropped off and picked up. in particular, the depots do not have to be operated by a delivery company.

A related embodiment of the method and of the system is characterized in that a notification is sent to the additional participant on the basis of the selection of the additional participant, and in that the mailpiece is transferred at the transfer point on the basis of an acceptance message sent by the additional participant in response to the request. As is also the case for the participant who takes over the mailpiece at the depot, the additional participant is only designated to transport the mailpiece over an additional partial segment if he declares his willingness to do so.

Moreover, in one embodiment of the method and of the system, it is provided that, when the mailpiece is handed over to the additional participant, the identity of at least one of the participants involved in the transfer and/or the identity of the mailpiece is checked, and it is provided that the checking procedure is carried out especially with the cooperation of one of the participants involved. In this manner, it can be ensured that the right mailpiece is taken over by the right participant.

A related embodiment of the method and of the system is characterized in that the checking procedure is carried out by means of a communication terminal device of the cooperating participant, and identification data pertaining to the mailpiece and/or to the other involved participant is acquired by means of said communication terminal device, whereby, in order to check the identification data, information is used that is made available by a server that can be connected to the communication terminal device via a communication network. Here, the identification data can be transmitted to the server in order to be checked. By the same token, it can be provided that the server transmits the information to the communication terminal device of the participant in order to be checked.

In one embodiment of the method and of the system, in order to transport the mailpiece over at least one partial segment of the delivery route, one or more participants for whom routes are stored that run within a predefined area surrounding the depot and/or the destination address are selected on the basis of the evaluation of the stored routes. The predefined surrounding area can encompass an area within a circle having a predefined radius around the depot and/or around the destination address. This embodiment allows for the mailpiece to be transported by the participants on routes that they travel on anyway, that is to say, irrespective of whether they are transporting a mailpiece or not. This translates into especially high savings in terms of resources during the delivery of mailpieces. Moreover, it can be expected that the participants of the delivery service wish to only have to leave their routes to a small extent or not at all in order to transport the mailpieces.

In one embodiment of the method and of the system, the partial segments of the delivery route are determined on the basis of sections of the routes stored for the participants in such a way that the delivery route meets at least one optimization criterion, and request messages are sent to the participants who are associated with stored routes that are at least partially comprised in the determined delivery route. Here, for example, a delivery route can be determined that consists of the smallest possible number of partial segments, as a result of which the number of transfers of the mailpiece between participants of the delivery service along a delivery route can be kept to a minimum. By the same token, if the optimization criteria are selected properly, for example, the shortest or fastest route through the network of stored routes of the participants can be determined.

In the embodiment described above, it can happen that not all participants to whom a request message is sent are willing to transport the mailpiece over the partial segment of the delivery route associated with them. In this case, the mailpiece cannot be delivered via the determined delivery route to the destination address. Therefore, a related embodiment of the method and of the system provides that the delivery route is determined anew if acceptance messages are not received in response to all of the request messages within a predefined period of time, and it provides that, when the delivery route is determined anew, the routes of the participants from whom no acceptance message was received within the period of time are not taken into consideration.

Another embodiment of the method and of the system is characterized in that, for at least a partial segment of the delivery route, a request message is sent to a plurality of participants and a participant from whom an acceptance message has been received is selected to transport the mailpiece over the partial segment. In this embodiment, the delivery route is not determined on the basis of an optimization criterion but rather, partial segments are each “offered” to a plurality of participants who can declare their willingness to transport the mailpiece by sending an acceptance message.

Participants to whom a request message is sent pertaining to the first partial segment are preferably the participants for whom a route is stored that runs within a circle around the depot. Acceptance messages pertaining to additional partial segments can be sent to participants for whom a route is stored that runs within an area surrounding the route of the preceding partial segment. These participants can take over the mailpiece from the participant who is associated with the preceding partial segment, without the participants having to move very far from their stored routes.

From among the participants who send an acceptance message in response to the request message addressed to them, for example, the participant to be selected and designated to transport the mailpiece can be the one whose acceptance message was the first to be received. By the same token, the selection of the participant to transport the mailpiece can also be made on the basis of another criterion.

Furthermore, one embodiment of the method and of the system entails that the server provides a communication platform that is configured to establish communication between a recipient and at least one additional participant of the service.

In a refinement of the method and of the system, the server is configured to transmit a price indicated by the recipient to the at least one first participant of the service as an offer for the delivery, whereby the acceptance of the offer can be transmitted to the server by the at least one first participant. Here, the price indicated by the recipient can be set on a slider. The at least one first participant of the service will consider whether he would like to take over the transport of the mailpiece over at least a partial segment for the offered price. If he does not wish to do so, he does not have to do anything. Since no offer acceptance from him is detected, no such offer acceptance is transmitted to the recipient. If no potential carrier is willing to transport the shipment at least over a partial segment, no offer acceptance is transmitted to the recipient. The recipient can then modify the offer, for example, by raising the price he is willing to pay.

If the delivery route is divided into several partial segments in that request messages pertaining to additional partial segments are sent to participants for whom a route is stored that runs in the vicinity of the preceding partial segment, these participants can take over the mailpiece from the participant with whom the preceding partial segment is associated, without the participants having to move very far from their stored routes. The additional participant preferably takes over the transport of the mailpiece over a subsequent partial segment of the delivery route. Preferably, the transfer point for handing over the mailpiece to the additional participant can be agreed upon via the communication platform.

In the above-mentioned embodiment, the delivery route is not predefined for the participants but rather, the participants can determine the delivery route themselves. For this purpose, participants who have taken over a mailpiece and do not wish to transport it all the way to its destination address can use the communication platform to reach an agreement with the additional participant about handing over the mailpiece to an additional participant for further transport. Via the communication platform, the participants can also agree upon the transfer point for handing over the mailpiece.

The above-mentioned as well as other advantages, special features and practical refinements of the invention are also explained with reference to the embodiments that are described below with reference to the figures.

### BRIEF DESCRIPTION OF DRAWINGS

The figures show the following:

FIG. 1 is a schematic depiction of several depots associated with a distribution center and of an associated server that communicates with the participants of a delivery service,

FIG. 2 is a schematic depiction of examples of routes of participants that are stored in the server for the participants,

FIG. 3 is a schematic depiction of an example of a route that runs through the network of participant routes and that has been determined in one embodiment,

FIG. 4a is another schematic depiction of examples of participant routes and a selection of participants determined in one embodiment, whereby said participants can transport mailpieces over a first partial segment leading from a depot to a destination address, and

FIG. 4b is a schematic depiction of the examples of participant routes and a selection of participants designated in the embodiment, whereby said participants can transport mailpieces on a second partial segment leading from the depot to the destination address after a participant has been designated for the first partial segment.

### BEST MODE FOR CARRYING OUT THE INVENTION

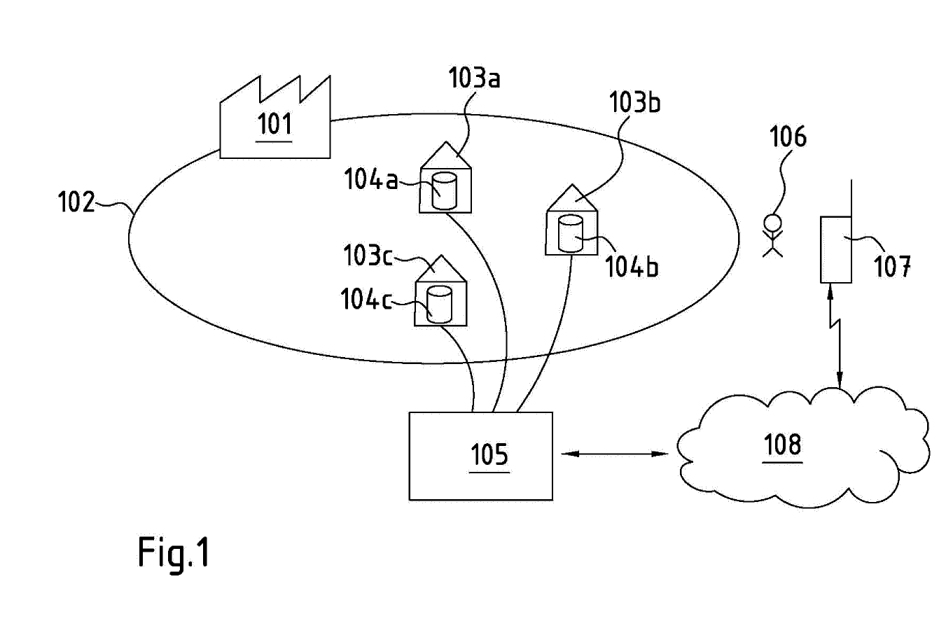

The distribution center 101 depicted by way of an example in FIG. 1 can be one of several distribution centers that are operated by a delivery company in a geographic area that it services. In the embodiment shown, the distribution center is associated with a geographic region 102. This especially means that mailpieces that are delivered in the region 102 are first transported to the distribution center, from where they are distributed further. Moreover, it can be provided that mailpieces that are mailed in the region 102 are collected in the distribution center 101 and, from the distribution center 101, are distributed among the regions in which the mailpieces are to be delivered. The mailpieces that are to be processed in the distribution center 101 can be, for example, letters and/or parcels.

A plurality of depots 103i (i=a,b,c) of the provided delivery service are associated with the distribution center 101 and, by way of example, three of these depots 103a,b,c are shown in FIG. 1. At the depots 103i, the mailpieces to be delivered by the delivery service are picked up by the participants 106 of the service. The depots 103i are preferably in the region 102 associated with the distribution center 101. In particular, the depots 103i can be located within the city limits, preferably near central places or similar localities. In the depots 103i, mailpieces that are brought in from the distribution center 101 can be stored temporarily until they are handed over to a participant 106 of the delivery service. The depots 103i can be any establishments where mailpieces can be dropped off and picked up. For example, these can be branches of the delivery company that are operated by personnel present there, or these can be automatic facilities such as so-called parcel compartment systems for releasing parcels. By the same token, the depots 103i can also be kiosks, cafes, bars, bistros, restaurants or the like. Thus, such establishments, if they so desire, can be part of the delivery network of the proposed delivery service. In order to administer the stored mailpieces and in order to control the releasing of the mailpieces to the participants 106 of the delivery service, the depots 103i are preferably each equipped with a computer unit 104i. In the embodiment of the system shown in FIG. 1, the computer units 104i are connected to a central server 105 of the delivery service. The connection can be made via a communication network such as, for example. the Internet and/or via a network operated by the delivery company.

The participants 106, 106i, 106′i, 106″i of the delivery service, one of whom is shown by way of example in FIG. 1, make use of communication terminal devices 107 that can be connected to the server 105 via a communication network 108. Preferably, the communication terminal devices 107 are mobile terminal devices that can also be carried along by the participants 106, 106i, 106′i, 106″i on their route. In particular, the communication terminal devices 107 can be in the form of mobile phones, smartphones, notebook computers or the like. The connection between the communication terminal devices 107 and the communication network 108 is preferably established wirelessly, for example, by mobile radio or WLAN (Wireless Local Area Network). The participants 106, 106i, 106′i, 106″i are registered in a participant database 109 in the server 105. The registration of the participants 106, 106i, 106′i, 106″i is preferably made under a user name.

The participants 106, 106i, 106′i, 106″i can use their communication terminal devices 107 to receive notifications that are sent by the server 105 via the communication network. For this purpose, the communication terminal devices 107 can have a software program that is configured to display the content of notifications from the server 105 to the communication terminal device 107 and, on the basis of user input, to send messages to the server. By the same token, the participants 106, 106i, 106′i, 106″i can send messages to the server 105 by means of their communication terminal devices 107. In one embodiment, these messages can be generated by means of the software program. They are preferably sent together with information that permits an identification of the users in the server 105. For this purpose, for example, the user name of the specific participant 106, 106i, 106′i, 106″i can be inserted into the messages, or else the messages are sent together with other information such as, for instance, the identifiers of the communication terminal devices 107 of the participants 106, 106i, 106′i, 106″i, whereby the server 105 can associate said identifiers with the user name.

Moreover, in one embodiment, the positions of the participants 106, 106i, 106′i, 106″i can be determined by means of the communication terminal devices 107 and reported to the server 105. For this purpose, individual messages can be initiated by the participants 106, 106i, 106′i, 106″i, or else the messages are sent automatically, especially at regular time intervals, to the server 105 after the participants 106, 106i, 106′i, 106″i have activated an appropriate functionality of the communication terminal device or of the software program. In order to detect the position, the communication terminal devices each have a suitable positioning device. This can be, for instance, a positioning device that works with satellite assistance such as a positioning device that uses the GPS (Global Positioning System) to detect the position.

For identification purposes within the scope of the delivery service, each participant 106, 106i, 106′i, 106″i is preferably assigned an identification feature that can comprise the user name or that can be another feature that is associated with the user name. The identification feature of a participant 106, 106i, 106′i, 106″i can be recorded in the depots 103i. Moreover, a participant 106, 106i, 106′i, 106″i can preferably record the identification feature of other participants 106, 106i, 106′i, 106″i. In order to do so, the participant 106, 106i, 106′i, 106″i can use his communication terminal device 107. In one embodiment, the identification feature of a participant 106, 106i, 106′i, 106″i is stored in the communication terminal device 107 of the participant 106, 106i, 106′i, 106″i and it can be read out at the depots 103i or by means of the communication terminal device 107 of another participant 106, 106i, 106′i, 106″i. For this purpose, the identification feature can be displayed on the communication terminal device 107 of the participant 106, 106i, 106′i, 106″i, for instance, in the form of a barcode, and can be read out by means of a reader that is available at a depot 103i or that is integrated into the communication terminal device 107 of another participant 106, 106i, 106′i, 106″i, or else it can be sent and received via a radio connection by means of an appropriate interface. The reader can be a barcode reader or a camera. The radio connection is preferably a near field connection that can be established, for example, by Bluetooth or NFC (Near Field Communication).

As an alternative to providing the identification feature by means of the communication terminal device 107 of a participant 106, 106i, 106′i, 106″i, the identification feature can also be provided in a different manner. Thus, in another embodiment, the identification feature is an identifier that can be entered by the participant 106, 106i, 106′i, 106″i at using input device of a depot 103i or of a communication terminal device 107 of another participant 106, 106i, 106′i, 106″i.

Moreover, aside from the identification features, the participants 106, 106i, 106′i, 106″i can also be assigned an authentication feature that permits the identity of the user to be checked. The authentication feature is preferably used for the authentication of messages from participants 106, 106i, 106′i, 106″i in the server 105 and likewise permits the authentication of participants 106, 106i, 106′i, 106″i by other participants 106, 106i, 106′i, 106″i as well as at the depots 103i. For this purpose, the identification and authentication feature of a participant 106, 106i, 106′i, 106″i can be recorded by another participant 106, 106i, 106′i, 106″i, for example, by means of his communication terminal device 107 or else at the depot 103i and then sent to the depot 103i in order to be checked. If the identification feature is made available electronically by means of the communication terminal device 107 of a participant 106, 106i, 106′i, 106″i, the authentication feature can be, for example, a digital signature that is provided in addition to the identification feature and that is verified with a cryptographic key that is associated with the participant 106, 106i, 106′i, 106″i. As described above, this can be carried out in the server 105. By the same token, it can also be provided that the key is sent by the server 105 to the communication terminal device 107 of a participant 106, 106i, 106′i,106″i or to a depot, where it is used to verify the authentication feature of another participant 106, 106i, 106′i, 106″i. In conjunction with a manual input, the authentication feature can be a PIN (personal identification number) of the user that is entered in addition to the identification feature. By the same token, other authentication features can also be used that permit an authentication of the participants 106, 106i, 106′i, 106″i in the server 105 as well as among each other.

The mailpieces that are transported within the scope of the delivery service by the participants 106, 106i, 106′i, 106″i are likewise provided with an unambiguous identifier. This identifier can be associated with the mailpieces in the distribution center 101 or, already prior to that, in another facility of the logistics network of the delivery company. The identifiers of the mailpieces can be recorded in the depots 103i and can also be recorded by means of the communication terminal devices 107 of the participants 106, 106i, 106′i, 106″i. In one embodiment, the identifiers are applied onto the mailpiece in the form of barcodes and they can be recorded by means of barcode readers or cameras of the communication terminal devices 107. In another embodiment given by way of an example, the identifiers are stored in contactless data media that are applied onto the mailpieces and that can be read out by means of appropriate readers of the communication terminal devices 107 that are employed.

Mailpieces that are dropped off at the distribution center 101 and that are intended for delivery by the delivery service are distributed from the distribution center to the depots 103i in the region 102. Aside from the mailpieces that are delivered by the provided delivery service, additional mailpieces processed in the distribution center 101 can also be delivered in the conventional manner in that they are transported all the way to their destination address by one carrier. The mailpieces delivered by means of the delivery service can fundamentally be selected in any desired manner. In one embodiment, it is provided that this is determined by the sender of the mailpiece. Here, a delivery fee that differs from the delivery fee for the conventional delivery can be established for the delivery by means of the delivery service. If the selection of the delivery service is made by the sender, this selection can be marked on the mailpieces in the same manner that is usually done for extra services. The marking is recognized during the processing of the mailpieces in the distribution center 101 and, after the recognition of the marking, the mailpiece is taken to the delivery service.

By the same token, the distribution of the mailpieces among the depots 103i can fundamentally be done in any desired manner. In one embodiment, it is provided that the mailpieces are each transported to the depot 103i that, among all of the depots 103i, is the closest to the destination address of the mailpiece in question. It can likewise be provided that the mailpieces are distributed to a predefined selection of depots 103i randomly and/or according to a predefined pattern. The selection can comprise a predefined number of depots 103i that are each closest to the destination addresses of the mailpieces. Likewise, the selection can comprise all of the depots in a given geographic area. For this purpose, districts, for example, can be defined within the region 102 associated with the distribution center, and the selection can comprise the depots in the district in which the destination address of the mailpiece is located. By the same token, the selection can also comprise, for example, all of the depots 103i in the region 102.

An example of a pattern according to which the mailpieces can be distributed among a selection of several depots is a so-called milk run concept. In this case, a new mailpiece is only directed to a depot 103i once another mailpiece has left this depot 103i (to be delivered). In this manner, it is prevented that a large number of mailpieces that are to be delivered accumulate at depots 103i where only a few mailpieces are picked up by participants 106, 106i, 106′i, 106″i of the delivery service. If, due to the distribution on the basis of the milk run concept, several depots 103i are options, then a random distribution can be made.

Moreover, it can be provided that the senders themselves can drop off the mailpieces at one of the depots 103i. Here, for a depot 103i, it is preferable to only permit the drop-off of mailpieces that are addressed to a destination address within a geographic area associated with that depot 103i. The geographic area can be, for example, an area in a predefined circle around the depot 103i or it can be a predefined district or a predefined region in which the depot is located. An example of such a district is the area of a city in which the depot 103i in question is located. Whether or not the mailpiece is a permissible mailpiece in the above-mentioned sense of the word is checked at the time of drop-off. This can be done manually by depot personnel or—especially if the depot 103i is configured as an automatic facility—by an automated electronic verification procedure. This prevents that the participants 106, 106i, 106′i, 106″i of the delivery service have to make deliveries over large distances.

From the depots 103i, the mailpieces are transported by the participants 106, 106i, 106′i, 106″i of the delivery service to their destination addresses. As a rule, this is the destination address 302, 401 applied onto the mailpiece by the sender, and this can be, for instance, the mailing address of the recipient. In order to deliver a mailpiece, selected participants 106, 106i, 106′i, 106″i of the delivery service who are registered in the server 105 are notified about the mailpiece. The participants 106, 106i, 106′i, 106″i can then take over the transport of the mailpiece from the depot 103i to the destination address or over a partial segment of the delivery route. For this purpose, communication is established especially between the server 105 and the participants 106, 106i, 106′i, 106″i, and this communication is carried out by the participants 106, 106i, 106′i, 106″i using their communication terminal devices 107. The communication can especially comprise requests from the server 105 to participants 106, 106i, 106′i, 106″i as to whether they want to take over the transport of a mailpiece, and it can also comprise responses from the participants 106, 106i, 106′i, 106″i to these requests. Moreover, the participants 106, 106i, 106′i, 106″i can receive additional information about the mailpieces and about the intended routes of the mailpieces from the server 105. Furthermore, the participants 106, 106i, 106′i, 106″i can confirm to the server 105, for example, the pick-up and the delivery of mailpieces by means of their communication terminal devices 107. For the transport of the mailpieces, the participants 106, 106i, 106′i, 106″i preferably receive a remuneration that is transacted via the server 105. Here, the recipient indicates how much the transport of the mailpiece on each partial segment is worth to him and he enters this price into the server 105 by means of a communication terminal device 107. In this context, the server 105 provides ranges and/or a recommendation. In one embodiment, the range and/or the recommendation are determined as a function of the distance over which the participant transports the mailpiece. By the same token, it can be provided that the range and/or the recommendation depend on how much time it will take to transport the mailpiece, whereby, at times when fewer participants 106, 106i, 106′i, 106″i of the delivery service are available, a higher remuneration can be provided, as a result of which the range and/or the recommendation are modified accordingly. The distance-dependent and/or time-dependent range and/or recommendation can be made on the basis of predefined fixed tables. The remuneration can be paid in actual money or in monetary units. For example, the payment can be made in points or in so-called credits that can be redeemed by the participants 106, 106i, 106′i, 106″i for money, products and/or services.

The number of credits that a participant 106, 106i, 106′i, 106″i of the system receives for a transport is specified by the recipient within the limits defined by the server 105. The recipient can retroactively change credits that have already been specified for a mailpiece as long as the mailpiece has not yet been reserved.

In addition to the credits that the recipient pays the deliverer (participant 106, 106i, 106′i, 106″i) for the transport, a service fee can be charged by the operator of the server 105. This fee is likewise expressed in terms of credits and is paid for the recipient. To start with, each user 106, 106i, 106′i, 106″i can receive a welcome bonus in order to first test the service free of charge. The term “user” is employed here and below to refer to any participant 106, 106i, 106′i, 106″i and any recipient. Afterwards, the user has to acquire additional credits in the form of a payment. Earned credits—except for the welcome bonus—can be paid out.

In order to implement the system for settling the accounts, clearing accounts are set up in the backend. For one thing, a user account is set up for each user of the service. Moreover, there are four global settlement accounts:
Account 1: contra account
Deposits and outpayments are offset against each other in this account. It constitutes the logical connection between the internal accounts, which are transacted in credits, and the external accounts of the users, and it serves for purposes of transparency of the cash flow,
Account 2: bonus account
The credits of the welcome bonus as well as other credit entries are debited from this account. Analogously to the contra account, this serves for purposes of transparency of the cash flow. A paid-out welcome bonus initially does not constitute a real monetary value; only once it is used to pay for a delivery does real money flow, which has to be covered via an escrow account of the server operator.
Account 3: fee account
Fees incurred within the scope of a completed delivery are credited to the fee account.
Account 4: transaction account
Every transaction between two accounts is temporarily booked into the transaction account. Reservations of credits are also made via this account in order to ensure that an envisaged payment for a mailpiece is covered and that no other mailpieces can be submitted by the user. The internal accounts form a closed system based on the artificial currency of “credit”. This artificial currency is generated by deposits made by users or else converted into real money by outpayments to user accounts. Bonuses and fees are merely recorded in the internal accounts. It has to be ensured that the escrow account has sufficient coverage to be able to pay out or convert credits that have been entered into the system as welcome bonuses. By the same token, via the fee account, it can be ascertained how many credits could be debited from the escrow account in order to effectuate the fee receipts.

Each user receives a welcome bonus. This bonus is not allowed to be paid out. Therefore, the user accounts are transacted in such a way that the bonus and other credit balances can be distinguished from each other. When remuneration for a delivery is made, first of all, the credits from the welcome bonus are used. After the transaction has been carried out, the credits of the welcome bonus become “normal” credits that can be used by the recipient or that can be paid out. Credits are likewise granted in order to acquire certain statuses such as, for example, the “most parcels per month” badge. In contrast to welcome bonuses, these credits are not limited in terms of their use and they can be paid out immediately after being received. Since, analogously to the welcome bonus, they have to be covered by the contra account, they are likewise booked from the internal account 2 (bonus account).

The credits are deposited into or paid out of user accounts, respectively, outside of the system and this is merely initiated by means of the system in that, for example, a web browser is opened and then a website of the payment provider. For instance, deposits by means of credit cards and outpayments by means of credit entries into bank accounts are options as a payment modality.

As described above, deposits and outpayments are additionally logged on the internal contra account so as to have a balanced balance over all of the internal accounts and for purposes of complete transparency of the money or credit flow. After a deposit or outpayment has been made, the user is redirected to a landing page one which he is given a success message or, in case of an error, a failure message. In addition, secured server-to-server communication takes place between the payment provider and the backend, which triggers the appropriate entries into the internal accounts.

As soon as a mailpiece can be reserved by setting the delivery fee, the credits including the delivery fee are subtracted from the recipient (user). The subtracted credits first appear under the heading “reserved credits”; they are only listed in the history once the mailpiece has been handed over. If the mailpiece is not handed over, the subtraction of the credits is reversed. As long as credits are tied up in a reserved transaction, they can neither be paid out nor used to submit another mailpiece.

Administrators have the possibility to credit individual users via the modality of admin-backend credits. The credit entry is booked from the bonus account, analogously to the bonuses such as the welcome bonus and the badge bonus.

Procedure for arranging the delivery of a new mailpiece

### Step 1: Input of the Track & Trace Number:

After the track & trace number has been successfully input, the number of credits for this mailpiece is set:

Prerequisite: the user has more credits than the minimum for this mailpiece.

The user receives a display of how many credits he currently still has available.

The user selects the desired number of credits on a scale by means of a controller or slider.

If the user has fewer credits than the maximum possible, this range is marked on the scale for him

If he selects a value that is within this range, he is shown a prompt and a button indicating that he first has to load his credits.

The displayed additional fee is modified accordingly.

At the end, there is a display indicating how many credits are needed in total.

By clicking on “save”, the user is directed to enter the delivery slots.

By clicking on “cancel”, the process is aborted and the user is directed to a mailpiece detail page.

### Step 2—Alternative 1:

Selection of the credits (the user still has sufficient credits):

### Step 2—Alternative 2:

Selection of the credits (the user has fewer credits than maximally possible):

The slider is divided into two ranges: the normal display is on the left, and the range that exceeds his current account is on the right.

If the user moves the slider to an amount with which he can no longer submit a mailpiece (that is to say, credits for the participant 106, 106i, 106′i, 106″i plus the fee), a message as well as a deposit button appears. This button takes him to the page “deposit credits”.

The “next” button becomes inactive.

The values for the slider are set as follows:

The server operator sets a minimum and a maximum.

The displayed recommendation is based on the weight and size of the mailpiece. If at least one of these values is not available, the value for “medium” is taken.

If the user has fewer credits than the maximum but more than the minimum, then the range between the maximum credits with which he can still submit a mailpiece (that is to say, credits for the participant 106, 106i, 106′i, 106″i plus the fee) and the maximum is marked accordingly.

If the user moves the slider to an amount that he does not have available, he is shown a prompt message as well as a deposit button. This button takes him to the page “deposit credits”.

In this case, the “next” button is deactivated.

The same applies to the recommendation.

The minimum is 50 credits.

The maximum is 300 credits.

The service fee is 10%.

The recommendation is 270 credits.

The user still has 250 credits.

The display shows the user 50 credits as the minimum and 300 credits as the maximum.

The range between 227 and 300 is marked accordingly (227 credits, since 227 credits+10% fee=250 credits).

He is shown 270 credits as the recommendation.

A prompt with a deposit button is displayed to him.

The “next” button is deactivated.

Prompt message in case of too few credits

If the user has fewer credits than the minimum, then, rather than the credit selection page, he is shown a prompt page with the information as to how to proceed.

The “deposit credits” button links to the appropriate “deposit credits” page.

By clicking on “cancel”, the user is directed to the detail page.

### Detail Page

Recipient with established credits

on the detail page, the recipient receives a precise list of what the credits consist of for this mailpiece.

In the navigation bar, there is additionally a navigation item in order to process the credits.

Recipient without established credit

If the user has not yet established any credits, then a prompt is displayed to him.

Deliverer detail page (participant 106. 106i, 106′i, 106″i)

On the detail page, the deliverer 106, 106i, 106′i, 106″i is only shown the credits that he himself would receive for the delivery.

### Overview of Credits

Depiction of the current account balance as well as of the welcome bonus contained there (this is only shown if he has welcome bonus credits).

Credits are reserved until a mailpiece has been delivered, picked up by the person himself, sent back or removed from the process by the call center. if one of the above-mentioned cases occurs, the reserved credits including the service fee are credited to the recipient.

Once the mailpiece has been delivered, the credits are debited from the recipient and credited to the deliverer (participant 106, 106i, 106′i, 106″i).

Buttons to “deposit” credits or to “pay out” credits.

If no credits can be paid out. then the “pay out” button is pale.

At the end of the page, the history is displayed with all of the deposits and outpayments, credits received for the delivery, bonus credits and extra payments for badges.

### Deposit of Credits

When the user clicks on the “deposit” button, a dropdown menu with possible deposit amounts is displayed to the user.

### Outpayment of Credits

The outpayment of credits works the same way as the deposit of credits.

The display shows the user how many credits he can currently pay out and how many cannot be paid out (e.g. since they are reserved for mailpieces or else the welcome bonus).

The user has the possibility to select the number of credits from a dropdown menu.

The only charges displayed are those that can, in fact, be paid out (depending on the credits he has available for outpayment).

### Deleting an Account

When an account is deleted, the user receives the prompt that credits that are still present but have not been paid out will expire, but that they can first be paid out to him.

In the server 105, at least one route can be stored for each registered participant 106, 106i, 106′i, 106″i of the delivery service. By the same token, it is also possible for several routes to be stored for a participant 106, 106i, 106′i, 106″i. For each stored route, a time is indicated at which the participant 106, 106i, 106′i, 106″i will be traveling along a given route. This can be a time at which the participant 106, 106i, 106′i, 106″i travels the route one time. By the same token, times at which the user regularly travels the route can be stored, whereby, for example, it can be specified that the user travels the route daily or on workdays at a specific time. Moreover, regarding the time for traveling the route, specific permissible deviations from the stored time are assumed, so that for each point along the route, there is a time span during which that point can presumably be reached, and not only one single fixed point in time. A predefined value can be taken as the basis for the permissible deviation. Optionally, the participant 106, 106i, 106′i, 106″i can be offered the possibility to indicate the permissible deviation himself.

The stored routes can be, for instance, the daily trips of the participants 106, 106i, 106′i, 106″i of the delivery service from their homes to their places of work and back. By the same token, however, it is also possible for the server 105 to store routes that are traveled one time, along with their associated times. In one embodiment, in order to store the routes, the server 105 provides an electronic interface that can be used by the participants 106, 106i, 106′i, 106″i to indicate routes. The interface can be, for example, a web portal that the participants 106, 106i, 106′i, 106″i access via the Internet using an Internet-capable terminal device.

The routes stored in the server 105 together form a route network in the region 102 with routes that are traveled by the participants 106, 106i, 106′i, 106″i of the delivery service at certain times. Preferably, the depots 103i in the region 102 are each located on at least one route of the route network. This means that they are either located on such a route or they are at a small distance from a route that does not exceed a predefined maximum value. Such an arrangement can be achieved by an appropriate set-up of depots 103i as a function of the stored routes, or by a suitable route selection of participants 106, 106i, 106′i, 106″i of the delivery service. These participants 106, 106i, 106′i, 106″i can be prompted in a suitable way, for example, when they enter routes via the web portal, to specify their routes in such a way that they pass at least one depot 103i. Moreover, the aim is to establish the most comprehensive possible route network in which, to the extent possible, every conceivable destination address within the region 102 is located on at least one stored route, that is to say, on this route or within a small distance from the route. The better the region 102 is covered by the routes of the participants 106, 106i, 106′i, 106″i of the delivery service, the more destination addresses can be serviced by the delivery service and the more easily delivery routes can be set up for the mailpieces that are being transported by the delivery service.

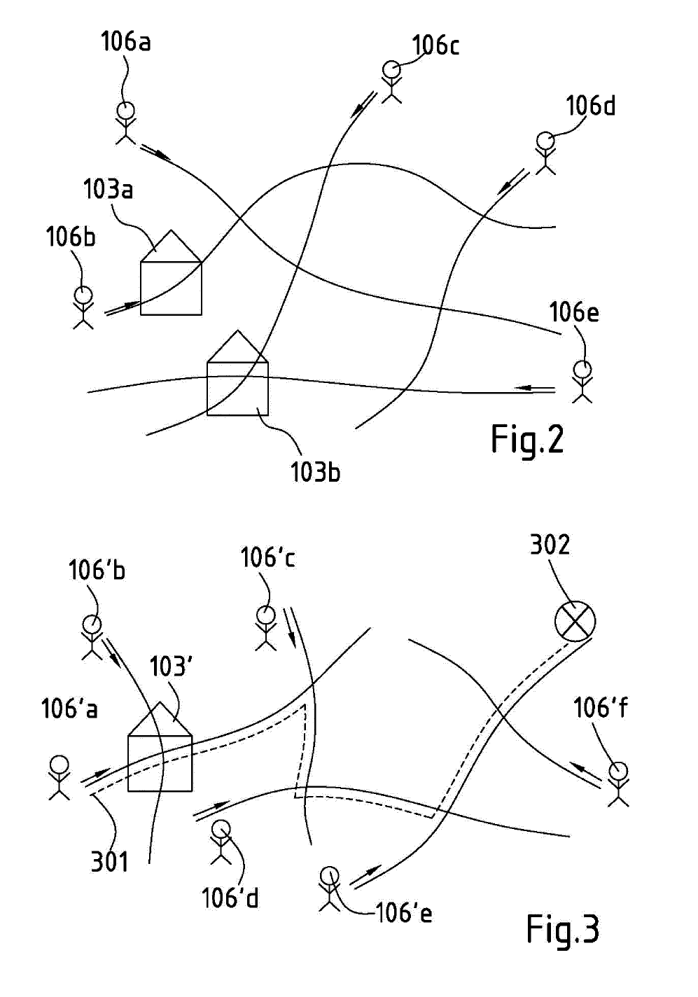

FIG. 2 shows routes by way of example and schematically that have been stored in the server 105 for five participants 106a-106e. The routes run along streets and roads of the region 102 that are, however, not shown in FIG. 2. Moreover, FIG. 2 shows a depot 103a that lies on the route of participant 106b, as well as a depot 103b that lies on the routes of participants 106c and 106e. The routes of participants 106a and 106d do not come past any of the depots 103i shown here.

In one embodiment of the server 105, the stored routes of the participants 106i are used to determine delivery routes on which the mailpieces held at the depots 103i are to be delivered to their destination addresses. The delivery routes are determined individually for each mailpiece or for each destination address, and they are made up of one or more sections of stored participant routes. Below, the determination of the delivery route and the subsequent delivery will be explained for one single mailpiece by way of example. The delivery route is determined for the transport of the mailpiece at a certain time, whereby the communication with the participants 106, 106i, 106′i, 106″i during the determination of the route preferably takes place shortly before the intended transport of the mailpiece, so that the participants 106, 106i, 106′i, 106″i can better assess whether they can take over the transport of the mailpiece or not. In one embodiment, in order to determine the delivery route for a mailpiece that is held at a given depot 103i, the server 105 first determines a route leading from the depot 103i where the mailpiece is being held to the intended destination address. The route can comprise one or more partial segments that are each a component or section of a route of a participant 106i of the delivery service. The delivery route is thus essentially made up of route sections of the participant routes, whereby small deviations by the participants 106, 106i, 106′i, 106″i from the routes are permitted as will still be described in greater detail below. In the case of a delivery route consisting of only one single partial segment, the mailpiece is transported by one single participant 106i on his route leading from the depot 103i all the way to the destination address. In the case of delivery routes consisting of several partial segments, the mailpiece is transported by a different participant 106i along each partial segment. Each of the partial segments adjoin each other at a transfer point. The transfer point between a first and a second partial segment is intended for the participant 106, 106i, 106′i, 106″i of the first partial segment to hand over the mailpiece to the participant 106, 106i, 106′i, 106″i of the second partial segment.

When the delivery route is determined, in order to define the partial segment that starts from the depot 103i, 103′, 103″, the server 105 takes into consideration the stored participant routes that run precisely past the depot 103i as well as preferably the routes that run within a circle having a predefined diameter around the depot 103i. Accordingly, in order to determine the partial segment that ends at the destination address, the participant routes taken into consideration are the ones on which the destination address is located, and preferably also participant routes that run within a circle having a predefined radius around the destination address. Moreover, in the case of delivery routes that are made up of several partial segments, in order to determine a partial segment (except for the first one), the only stored participant routes taken into consideration are those that intersect a participant route on which the preceding partial segment runs or else that run in the vicinity of the route that has a predefined maximum length. Therefore, the delivery route does not have to run precisely along a path through the network of the stored participant routes but rather, smaller deviations from the route network are also possible. This simplifies the calculation of the route.

In the case of delivery routes consisting of several partial segments, not only the physical connections of the consecutive partial segments, but also time connections are taken into consideration. Here, sections of participant routes are only selected as adjoining partial segments of the delivery route if a. transfer point between the routes can be determined where both participants 106i meet within a predefined time span. Whether or not such a transfer point exists is determined on the basis of the times stored by the participants 106i regarding when the participants 106i travel along their route, and also on the basis of the applicable permissible time deviation (that is to say, especially the fixed predefined time deviation or the time deviation indicated by the participant).

In one embodiment, in order to determine the delivery route, the server 105 determines a path through the network of the stored participant routes that is optimized relative to at least one predefined criterion. Such a criterion is the number of partial segments, whereby preferably the smallest possible number of partial segments is strived for in order to keep to a minimum the number of times the mailpiece is handed over among participants 106, 106i, 106′i, 106″i of the delivery service. Other criteria according to which the optimization can be augmented or alternatively carried out are the length of the traveled distance (which is preferably minimized) and/or the required time (which is preferably likewise minimized). A delivery route that has been optimized according to the prescribed criteria is determined in the server 105 by means of algorithms generally known to the person skilled in the art. First of all, a provisional delivery route is determined that, if applicable, becomes final when the participants 106, 106i, 106′i, 106″i who are to transport the mailpiece over this route agree to take over the transport of the mailpiece.

In a schematic depiction by way of example, FIG. 3 illustrates a delivery route 301 through the route network consisting of the participant routes leading from a depot 103i to a destination address 302. The delivery route 301 follows the broken line and is made up of partial segments that each belong to the route of one participant 106i. The delivery route shown by way of example consists of sections of the routes that are stored in the server 105 for four participants 106′a and 106′c,d,e. In addition, FIG. 3 also shows sections of the routes of other participants 106′b and 106′f that are not part of the delivery route 301. As explained above, the delivery route 301 is preferably an optimal route as defined by an optimization criterion upon which the route determination was based. This means that, within the route network consisting of the stored participant routes, additional contiguous routes, which can be formed leading from the depot to the destination address 302 and which are not shown in FIG. 3, These can be, for example, routes whose first partial segment is associated with participant 106′b on whose route the depot 103i is located.

The participants 106, 106i, 106′i, 106″i of the delivery service are selected to transport the mailpiece on the basis of the previously determined provisional delivery route. In this context, the participants 106, 106i, 106′i, 106″i selected are those whose routes, at least in sections, are comprised in the delivery route. A message is sent to each of the participants 106, 106i, 106′i, 106″i who have been selected on the basis of the provisional route layout. Each message specifies the partial segment of the provisional delivery route that is associated with the participant 106, 106i, 106′i, 106″i and this message contains a request as to whether the participant 106, 106i, 106′i, 106″i is willing to take over the transport of the mailpiece over the partial segment in question for the price proposed by the recipient. In addition, times can be indicated at which the participant 106, 106i, 106′i, 106″i is supposed to pick up the mailpiece at the beginning of the partial segment or is supposed to hand it over at the end of his partial segment. This is especially advantageous if the participant 106, 106i, 106′i, 106″i takes over the mailpiece from another participant 106, 106i, 106′i, 106″i at a transfer point between two partial segments of the delivery route, or if he is supposed to hand over the mailpiece to another participant 106, 106i, 106′i, 106″i at the end of the partial segment at a transfer point. The times preferably correspond to the times stored for traveling along the participant routes, taking the permissible deviations into consideration.

The message is sent to the communication terminal device 107 of the participant 106, 106i, 106′i, 106″i in question and the content of the message is displayed on the communication terminal device 107. The partial segment to which the request contained in the message refers can be indicated, for example, by its starting and ending points, or it can be shown on a map that is displayed on the communication terminal device 107. A participant 106, 106i, 106′i, 106″i who has received a request message from the server 105 can use his communication terminal device 107 to send to the server 105 a response answering the request message. In his response, the participant 106, 106i, 106′i, 106″i can accept the request, that is to say, he can declare his willingness to transport the mailpiece over the partial segment of the delivery route that was indicated in the request message. If the participant 106, 106i, 106′i, 106″i is not willing to do so, he can use his communication terminal device 107 to send a declining message to the server 105 or, as an alternative, he can remain silent, that is to say, he can leave the request message unanswered.

If, within a predefined time interval after the request message has been sent, the server 105 has received an acceptance message from all of the participants 106, 106i, 106′i, 106″i who were selected to transport the mailpiece, the previously determined provisional delivery route is marked as being final. Moreover, the server 105 sends a confirmation message to each of the participants 106, 106i, 106′i, 106″i who will be taking over the transport of the mailpiece on the delivery route. Each confirmation message can once again specify the partial segment of the delivery route associated with a particular participant 106, 106i, 106′i, 106″i as well as, if applicable, the time at which the mailpiece is to be taken over from the participant 106, 106i, 106′i, 106″i at the beginning of his partial segment or handed over at the end of his partial segment. Moreover, the confirmation message for the participant 106, 106i, 106′i, 106″i with whom the first partial segment is associated indicates the depot 103i where he is to take over the mailpiece, and the confirmation message to the participant 106, 106i, 106′i, 106″i who will take over the transport on the last partial segment of the delivery route indicates the destination address of the mailpiece. If a participant 106, 106i, 106′i, 106″i is to take over the mailpiece from another participant 106, 106i, 106′i, 106″i at a transfer point that is between two partial segments, then the confirmation message indicates the identity of the other participant. By the same token, a participant 106, 106i, 106′i, 106″i who is to hand over the mailpiece to another participant 106, 106i, 106′i, 106″i at a transfer point is informed of the identity of this other participant 106, 106i, 106′i, 106″i. Moreover, the depot is informed of the identity of the participant 106, 106i, 106′i, 106″i who is to pick up the mailpiece there and, if applicable, the pick-up time. The indication of the identity of another participant in a confirmation message preferably includes the user name under which the participant 106, 106i, 106′i, 106″i is registered in the server 105. Aside from the above-mentioned information, the confirmation messages for all of the participants 106, 106i, 106′i, 106″i who are involved in the transport of the mailpiece—irrespective of the arrangement of their partial segment within the delivery route—also contain a specification of the mailpiece to be transported, preferably including the unambiguous identifier of the mailpiece.

If no acceptance message has been received within the predefined time span from any of the participants 106, 106i, 106′i, 106″i who were selected on the basis of the provisional delivery route, then the mailpiece cannot be transported to its destination address via the previously determined provisional route, and therefore, the server 105 carries out a new calculation of a provisional delivery route. This is especially true if a declining message is received from at least one participant 106, 106i, 106′i, 106″i in response to the request message sent by the server 105. The new calculation of a provisional delivery route is fundamentally made in the same way as the first calculation described above. However, in the determination of the route, the routes that were stored in the server 105 for participants 106, 106i, 106′i, 106″i who were selected on the basis of the previously calculated provisional delivery route and from whom no other message was received within the predefined time span are not taken into consideration. In contrast, the routes of the participants 106, 106i, 106′i, 106″i who, in response to the preceding request message, sent an acceptance message that was received in the server 105 are taken into consideration in the new calculation of the route. Once the server 105 has determined a new provisional delivery route, request messages are once again sent to the participants 106, 106i, 106′i, 106″i whose stored routes contain sections that are comprised in the newly calculated provisional delivery route. If acceptance messages in response to the request are received from these participants 106, 106i, 106′i, 106″i within the predefined time span, then the delivery route is marked as being final, and the participants 106, 106i, 106′i, 106″i are notified in the above-mentioned manner. If no acceptance message is received from any participant who was selected on the basis of the newly calculated delivery route, then the server 105 carries out another new calculation of a provisional delivery route, additionally excluding the routes of those participants 106, 106i, 106′i, 106″i from whom no acceptance messages were received. A new calculation of the delivery route and the subsequent transmission of request messages to the participants who are selected on the basis of the calculated delivery route are continuously repeated until a delivery route can be marked as being final and confirmation messages can be sent to the participants 106, 106i, 106′i, 106″i, or else until the server 105 can no longer determine a delivery route. This is the case if, within the route network that consists of the routes that are still to be considered after the declining messages, no path exists leading from the depot 103i where the mailpiece is located to the destination address. If no delivery route can be determined, another determination of a delivery route for the mailpiece can be repeated at another point in time, for example, on another day.

In an alternative embodiment, the delivery route of the mailpiece from the depot 103i to the destination address is not determined in the manner described above by taking an optimization criterion into consideration, but rather by means of an iteration process. In this process, the server 105 first selects participants 106, 106i, 106′i, 106″i of the delivery service who can be taken into consideration to transport the mailpiece over a first partial segment of the delivery route that is to be determined These can be all of the participants 106, 106i, 106′i, 106″i for whom the server 105 has stored a route that runs within a circle having a predefined radius around the depot 103i where the mailpiece is located. if this is the case for several participants 106, 106i, 106′i, 106″i, in one embodiment, the selection can be limited to the participants 106, 106i, 106′i, 106″i whose routes additionally meet another criterion. In particular, it can be provided that the selection is limited to those participants I 06, 106i, 106′i, 106″i for whom a route is stored on which the mailpiece would approach the destination address. These are routes that run within the predefined circle around the depot 103i and that, at least in sections, are closer to the destination address than the depot 103i is.

Then, a request message is sent to each of the selected participants 106, 106i, 106′i, 106″i. This message specifies the location of the depot 103i where the mailpiece is to be picked up and preferably also the destination address of the mailpiece. Moreover, the request messages can indicate the envisaged remuneration for the distance traveled from the depot 103i to the destination address, whereby this distance can be ascertained by the server 105 on the basis of the stored table. In response to the request messages, the participants 106, 106i, 106′i, 106″i can send acceptance messages with which they can indicate their willingness to transport the mailpiece. The request messages, in turn, are sent to the communication terminal devices 107 of the participants 106, 106i, 106′i, 106″i, and the acceptance messages are generated by means of the communication terminal devices 107 and sent to the server 105. Preferably, the participants 106, 106i, 106′i, 106″i can optionally indicate in the acceptance message that they are willing to take over the entire transport of the mailpiece all the way to the destination address (even if the destination address is not on the route of the participant 106, 106i, 106′i, 106″i). Thus, an advantage of this embodiment is that, deviating from their stored route, participants 106, 106i, 106′i, 106″i can transport the mailpiece over longer partial segments and even all the way to its destination address. However, if such information is absent from the acceptance message, only the willingness to take over the mailpiece at the depot 103i and to carry it along the route stored in the server 105 is being expressed.

In order to determine the delivery route, the server 105 considers all of the acceptance messages that are received within a predefined time span after the request messages have been transmitted and, on the basis of these acceptance messages, the server 105 determines the participant 106, 106i, 106′i, 106″i who is to transport the mailpiece over the first partial segment of the delivery route that is to be determined. If a participant 106, 106i, 106′i, 106″i has declared by means of his acceptance message that he is willing to transport the mailpiece all the way to its destination address, this participant 106, 106i, 106′i, 106″i is designated to transport the mailpiece. If several participants 106, 106i, 106′i, 106″i have declared in their acceptance messages that they are willing to transport the mailpiece over the entire delivery route, the server 105 selects one participant 106, 106i, 106′i, 106″i from among the participants 106, 106i, 106′i, 106″i on the basis of a predefined criterion and designates this participant 106, 106i, 106′i, 106″i to transport the mailpiece. Here, for example, the participant 106, 106i, 106′i, 106″i whose acceptance message was the first to be received in the server 105 can be selected.

Once a participant 106, 106i, 106′i, 106″i has been designated on the basis of his acceptance message for the entire transport of the mailpiece all the way to its destination address, the server 105 sends a confirmation message to the participant 106, 106i, 106′i, 06″i in which it is confirmed to the participant 106, 106i, 106′i, 106″i that he will carry out the transport of the mailpiece and in which the identifier of the mailpiece is indicated. After receipt of the confirmation message, the participant 106, 106i, 106′i, 106″i can carry out the transport of the mailpiece.

If no participant 106, 106i, 106′i, 106″i has sent an acceptance message indicating his willingness to transport the mailpiece all the way to its destination address, then, on the basis of the received acceptance message, a participant 106, 106i, 106′i, 106″i is selected for the first partial segment of the delivery route that . is to be determined. If the server 105 has received several acceptance messages within the predefined time span, the participant 106, 106i, 106′i, 106″i is selected on the basis of a predefined criterion from among the participants 106, 106i, 106′i, 106″i from whom an acceptance message was received. For example, once again, the participant 106, 106i, 106′i, 106″i whose acceptance message was the first to be received in the server 105 can be selected.

After the association of the first partial segment with a participant 106, 106i, 106′i, 106″i, the server 105 designates the participants 106, 106i, 106′i, 106″i for whom routes have been stored that run, in sections, near the route of the participant 106, 106i, 106′i, 106″i who has been designated for the first partial segment, or else routes that intersect this route. Then the server 105 sends a request message to each of the participants 106, 106i, 106′i, 106″i whose stored routes meet this condition. Each request message preferably contains information about the transfer point where that particular participant 106, 106i, 106′i, 106″i can take over the mailpiece from the participant 106, 106i, 106′i, 106″i designated for the first partial segment, as well as the destination address of the mailpiece and it also contains information about the price that the recipient is willing to pay. The transfer point corresponds to the point of intersection of the routes or else the place where the routes approach each other to within a prescribed maximum distance. Moreover, once again, the remuneration for the transport of the mailpiece from the transfer point all the way to the destination address can be indicated.

The request messages are received by the addressed participants 106, 106i, 106′i, 106″i by means of their communication terminal devices 107 and the information contained in the display messages is shown on the communication terminal devices 107. A participant 106, 106i, 106′i, 106″i can respond to a received request message by sending an acceptance message if lie is willing to transport the mailpiece for the indicated conditions. As already explained above regarding the request messages sent to the participants 106, 106i, 106′i, 106″i who were selected to transport the mailpiece over the first partial segment, a participant 106, 106i, 106′i, 106″i can optionally indicate in the acceptance message that he would like to transport the mailpiece from the transfer point specified in the request message all the way to its destination address. If the server 105 receives one or more such acceptance messages, then one of the participants 106, 106i, 106′i, 106″i who sent the acceptance messages is designated to transport the mailpiece from the transfer point all the way to the destination address, and a confirmation message to this effect is sent to this participant 106, 106i, 106′i, 106″i. This is done analogously to the explanation already given above in conjunction with the first partial segment of the delivery route.

If the server 105 receives only one or more acceptance messages in which participants 106, 106i, 106′i, 106″i of the delivery service declare their willingness to transport the mailpiece not to its destination address, but rather only on their stored route (which does not run past the destination address), then, on the basis of these acceptance messages, a participant 106, 106i, 106′i, 106″i is designated to transport the mailpiece over the second partial segment. If several acceptance messages have been received, one participant 106, 106i, 106′i, 106″i is selected from among the participants 106, 106i, 106′i, 106″i from whom an acceptance message was received in the server 105, and this participant 106, 106i, 106′i, 106″i is designated to transport the mailpiece over the second partial segment. Here, once again, the participant 106, 106i, 106′i, 106″i whose acceptance message was the first to be received in the server 105 can be selected, or else the participant 106, 106i, 106′i, 106″i whose route comes closest to the destination address is selected. If only one acceptance message is received, the participant who sent the acceptance message is associated with the second partial segment of the delivery route without any further evaluation.

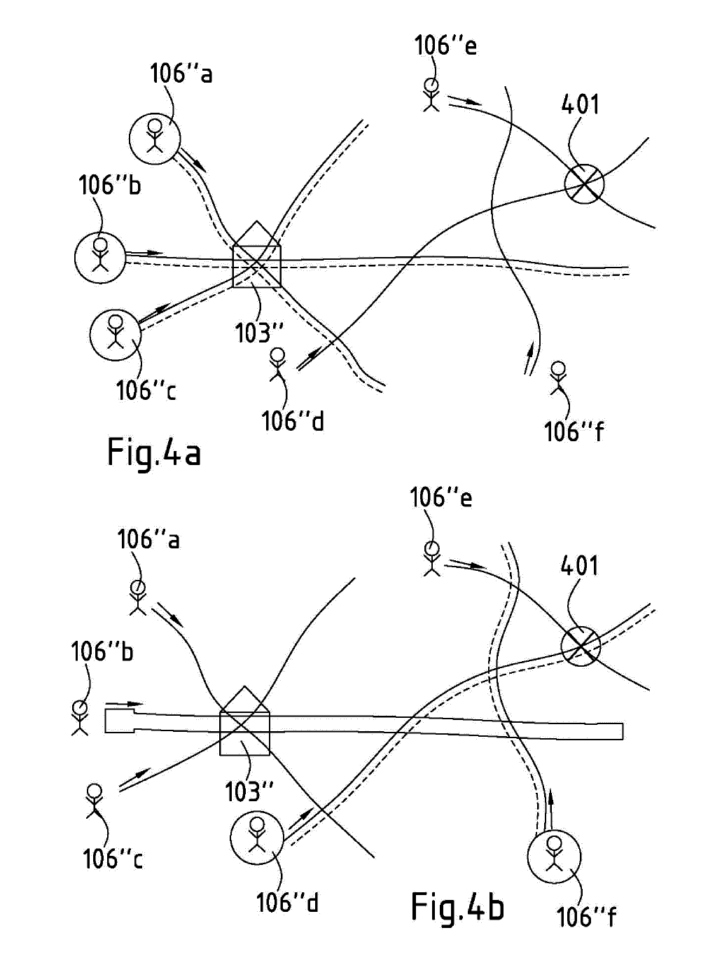

FIGS. 4a and 4b schematically show how two partial segments of a delivery route leading from a depot 103i to a destination address 401 are determined by means of the iteration process. In the first step, request messages are sent to the participants 106″a,b,c on whose routes the depot 103i is located. These routes are marked with broken lines in FIG. 4a. In the depiction of FIG. 4b, it is assumed that, in the first iteration step, the participant 106″b is selected to transport the mailpiece over a first partial segment on the basis of the acceptance message that he sent to the server 105. Therefore, the section of this route shown in FIG. 4b is drawn with a thicker line. In the second iteration step, request messages are sent to the participants 106″d and 106″g whose routes intersect the route of the participant 106″b. These routes are drawn with a broken line in FIG. 4b.

One or more additional partial segments of the delivery route are determined analogously to the second partial segment in one or more iteration steps. In each iteration step, an attempt is made to designate a participant who will take over the mailpiece at a transfer point from the participant who had been designated in the preceding iteration step for the preceding partial segment. For this purpose, in each iteration step, request messages are sent to the participants for whom routes are stored that intersect the routes of the participant who is associated with the preceding partial segment or else to the participants who approach this route to within a predefined maximum distance. The participants who take over the transport of the mailpiece over the partial segment are determined in each iteration step in the manner already described on the basis of the acceptance messages that were received in response to the request messages. In many cases, in this manner, a delivery route can be determined on which the mailpiece is transported from the depot 103i to its destination address.

In some cases, it can happen that, in an iteration step, no participant 106, 106i, 106′i, 106″i can be determined who can take over the mailpiece from another participant 106, 106i, 106′i, 106″i who, in the preceding iteration step, had been designated to transport the mailpiece over a partial segment of the delivery route. By the same token, it can happen that no acceptance messages are received within the predefined time span in response to the request messages send in an iteration step. For both of these cases, one embodiment provides that the server 105 discards the results of the preceding iteration step and attempts anew in this iteration step to designate a participant 106, 106i, 106′i, 106″i who can transport the mailpiece over a partial segment of the delivery route. Here, the participant 106, 106i, 106′i, 106″i previously designated in the iteration step is not taken into consideration. For the rest, the iteration step is repeated in the same manner as was done before. If a participant 106, 106i, 106′i, 106″i is determined here, then the iteration process is continued.

However, if no participant 106, 106i, 106′i, 106″i can be determined, then, for the partial segment of the delivery route that was relevant in the preceding iteration step, the server 105 attempts to determine a new participant 106, 106i, 106′i, 106″i who can transport the mailpiece. In other words, if no participant 106, 106i, 106′i, 106″i can be determined to transport the mailpiece in an iteration step, then the server 105 successively returns to the previous iteration steps and attempts to determine a different participant 106, 106i, 106′i, 106″i than before. The method is repeated until a delivery route leading from the depot 103i to the destination address has been determined or else until it is certain that such a delivery route cannot be determined. This is the case when, due to not taking into consideration participants 106, 106i, 106′i, 106″i who could take over the mailpiece starting at the depot 103i, in the repeated attempt to determine a participant 106, 106i, 106′i, 106″i for the first partial segment, there is no longer an available participant 106, 106i, 106′i, 106″i for whom a route is stored that runs past the depot 103i or near it.

In another embodiment, it can be provided that, in the case that, in an iteration step, the server 105 initially does not receive an acceptance message in response to request messages it has sent, the server 105 repeats the requests and, for this purpose, dynamically specifies a higher remuneration each time and offers this to the participants 106, 106i, 106′i, 106″i in the request messages. The higher remuneration is higher than the predefined fixed remuneration of the participants 106, 106i, 106′i, 106″i. In this manner, by raising the remuneration, an attempt is made to find a participant 106, 106i, 106′i, 106″i to transport the mailpiece over the partial segment. In an iteration step, several request messages can also be sent to all of the selected participants 106, 106i, 106′i, 106″i at prescribed time intervals, whereby the remuneration is raised each time a message is sent to a participant 106, 106i, 106′i, 106″i. After a fixed number of repetitions, however, it is preferable to conclude that there has been a failure to determine a participant 106, 106i, 106′i, 106″i in that particular iteration step and, in the manner described above, a new iteration step is carried out.

As soon as the server 105 has completely determined a delivery route leading from the depot 103i all the way to the destination address of the mailpiece by means of the iteration process, it sends a confirmation message to each of the participants 106, 106i, 106′i, 106″i of the delivery service who have been designated to transport the mailpiece over a partial segment of the determined delivery route. Each confirmation message preferably specifies the place where the participant 106, 106i, 106′i, 106″i in question is to take over the mailpiece, that is to say, it indicates the location of the depot 103i in the confirmation message to the participant 106, 106i, 106′i, 106″i who takes over the transport over the first partial segment of the delivery route, and it indicates the transfer point where, if applicable, the participants 106, 106i, 106′i, 106″i take over the mailpiece from another participant 106, 106i, 106′i, 106″i. Moreover, if applicable, the transfer point where a participant is supposed to hand over the mailpiece to the next participant 106, 106i, 106′i, 106″i is specified. The confirmation message to the participant 106, 106i, 106′i, 106″i who takes over the transport on the last partial segment indicates the destination address. If a participant 106, 106i, 106′i, 106″i is to take over the mailpiece from another participant 106, 106i, 106′i, 106″i and/or is to hand it over to another participant 106, 106i, 106′i, 106″i, then the confirmation message also contains the determined time at which the mailpiece is to be taken over or handed over. In addition, the other participants 106, 106i, 106′i, 106″i from whom the mailpiece is to be taken over and/or to whom the mailpiece is to be handed over are identified by their user names in the confirmation message. Moreover, the confirmation messages identify the mailpiece on the basis of the associated identifier. The depot is likewise informed about which participant is to pick up the mailpiece and, if applicable, at what time the mailpiece is to be picked up.

After a delivery route for the mailpiece leading from the depot to the destination address has been determined according to one of the embodiments described above and after the participants 106, 106i, 106′i, 106″i of the delivery service who were designated to transport the mailpiece have each received a confirmation message, the mailpiece is transported by the participants 106, 106i, 106′i, 106″i via the delivery route intended for this purpose.

In each case, the participants 106, 106i, 106′i, 106″i pick up the mailpiece at the intended locations and at the times that have optionally been prescribed by the server 105. This can involve taking over the mailpiece at the depot or else from another participant 106, 106i, 106′i, 106″i. When a participant 106, 106i, 106′i, 106″i takes over the mailpiece, he records the identifier of the mailpiece in the manner described above and reports it to the server 105 by means of his communication terminal device. Additionally, the participant 106, 106i, 106′i, 106i can report his position to the server 105. For this purpose, it can be provided that the participant 106, 106i, 106′i, 106″i appropriately enters his position in a suitable manner or else the position is automatically ascertained by the positioning device that is optionally installed in the communication terminal device 107. The server preferably verifies the authenticity of the message and also whether the correct mailpiece has been taken over, and checks whether said mailpiece was taken over by the participant 106, 106i, 106′i, 106″i who was designated to take over the mailpiece. In this process, it is also possible to check whether the mailpiece was taken over from the participant 106, 106i, 106′i, 106″i at the intended time. Moreover, if the position of the participant 106, 106i, 106′i, 106″i is reported, the server can also check whether the mailpiece was taken over at the intended location. After this checking procedure has been carried out successfully, the server 105 preferably sends a confirmation to this effect to the participant 106, 106i, 106′i, 106″i. Once the participant 106, 106i, 106′i, 106″i has received this confirmation, he can transport the mailpiece over the partial segment of the delivery route associated with him. Moreover, after the checking procedure has been carried out successfully, the fact that the participant is now in possession of the mailpiece is recorded. If the checking procedure cannot be carried out successfully, then an error routine can be initiated as a function of the failed checking step.

Moreover, the other participant 106, 106i, 106′i, 106″i or the depot that hands over the mailpiece to a participant 106, 106i, 106′i, 106″i checks whether this is the right participant 106, 106i, 106′i, 106″i, that is to say, the participant 106, 106i, 106′i, 106″i who was designated by the server 105 to transport the mailpiece and whose identity had been previously transmitted to the other participant 106, 106i, 106′i, 106″i or to the depot. Furthermore, the identity of the participant 106, 106i, 106′i, 106″i is verified. For this purpose, in the manner already described above, the identification feature and the authentication feature of a given participant 106, 106i, 106′i, 106″i can be recorded and sent to the server 105, which checks the identity of the participant 106, 106i, 106′i, 106″i and can send the result of the checking procedure back to the other participant 106, 106i, 106′i, 106″i or to the depot. The server 105 can also check whether this is the participant 106, 106i, 106′i, 106″i who is to take over the mailpiece from the depot or from the other participant. By the same token, this checking procedure can be carried out by the other participant 106, 106i, 106′i, 106″i or by the depot on the basis of the previously transmitted information. If the identity cannot be successfully verified, or if it is ascertained that this is not the correct participant 106, 106i, 106′i, 106″i to take over the mailpiece, then the mailpiece is preferably not handed over.

At a transfer point where a first participant 106, 106i, 106′i, 106″i hands over the mailpiece to a second participant 106, 106i, 106′i, 106i of the delivery service, the participants 106, 106i, 106′i, 106″i can identify each other on the basis of their user names, which were indicated in the confirmation messages that had been sent by the server 105 to the participants 106, 106i, 106′i, 106″i. The reciprocal identifications can take place in a conversation that is held between the participants 106, 106i, 106′i, 106″i. In order for the participants to recognize each other at the transfer point, appropriate recognition symbols can be provided. In one embodiment, these recognition symbols can be prescribed by the delivery service for all participants 106, 106i, 106′i, 106″i. For example, it can be provided that a participant 106, 106i, 106′i, 106″i who hands over a mailpiece at a transfer point to another participant 106, 106i, 106′i, 106″i can be recognized by the other participant 106, 106i, 106′i, 106″i on the basis of the mailpiece that the participant 106, 106i, 106′i, 106″i displays visibly. By the same token, it can be provided that the participants 106, 106i, 106′i, 106″i of the delivery service visibly carry certain symbols or objects in plain view.

In another embodiment, communication between the participants 106, 106i, 106′i, 106″i is made possible which they can effectuate by means of their communication terminal devices 107. For this purpose, the functions for communication with other participants 106, 106i, 106′i, 106″i are preferably provided through the software program of the delivery service, by means of which the participants 106, 106i, 106′i, 106″i can likewise communicate with the server 105. The communication can be in the form of text messages, or else voice communication can be established between the participants 106, 106i, 106′i, 106″i. Within the scope of the communication between the participants 106, 106i, 106′i, 106″i, they can especially make arrangements relating to the handing over of mailpieces at the intended transfer points. In this context, information can also be exchanged as to how the participants 106, 106i, 106′i, 106″i will recognize each other. Moreover, the communication between the participants also makes it possible for them to arrange, for example, different transfer points.

In one embodiment, the communication between the participants 106, 106i, 106′i, 106″i is effectuated via the server 105 which, for this purpose, establishes an appropriate communication platform. When it comes to the communication on the basis of text messages, text messages that are received from a participant and addressed to another participant 106, 106i, 106′i, 106″i can be forwarded to this other participant 106, 106i, 106′i, 106″i by the platform. The addressing can be effectuated on the basis of the user name of the other participant so that, beyond the user names, no personal data of the other participant 106, 106i, 106′i, 106″i such as, for instance, phone numbers or addresses, have to be disclosed. By the same token, it can be provided that the communication platform establishes voice connections between participants. This can involve, for example, Voice-over-IP connections. In order to establish a voice connection with another participant 106, 106i, 106′i, 106″i, a request to this effect can be directed to the server 105, indicating the user name of this participant. When a participant 106, 106i, 106′i, 106″i of the delivery service delivers a mailpiece at its destination address, he reports this to the server using his communication terminal device 107. In one embodiment, it is also provided that the delivery of the mailpiece is acknowledged by the recipient or by the person who accepts the mailpiece, as is also often the case with the conventional delivery of mailpieces, especially parcels. For purposes of acknowledgement, the participant 106, 106i, 106′i, 106″i can use his communication terminal device 107 to record, for instance, the name and a signature of the person accepting the mailpiece and he can send this to the server 105. The signature can be recorded, for example, on the touchscreen of the communication terminal device 107, or else a signature that is written onto a document that is present at the transfer location is recorded by the participant 106, 106i, 106′i, 106″i using a camera device of his communication terminal device 107. On the basis of the receipt of the message about the delivery and, if applicable, the acknowledgement by the accepting person, the server 105 notes that the mailpiece has been delivered and that is it no longer in the possession of the delivering participant 106, 106i, 106′i, 106″i of the delivery service.

On the basis of the communication of the participant 106, 106i, 106′i, 106″i and of the depot with the server 105 at the beginning and during the transport of the mailpiece, the server 105 is informed each time the mailpiece is handed over to a participant 106, 106i, 106′i, 106″i. Thus, at any given point in time, the server 105 always knows which participant 106, 106i, 106′i, 106″i has the mailpiece in his possession. Moreover, on the basis of the prescribed positions that may have been reported or prescribed by the delivery route where a participant 106, 106i, 106′i, 106″i has taken over and handed over or delivered the mailpiece, the server 105 can determine the route via which the participant 106, 106i, 106′i, 106″i has transported the mailpiece.

Another embodiment of the delivery service differs from the embodiments described above in that the delivery route is not determined by the server 105 before the first participant 106, 106i, 106′i, 106″i designated to transport the mailpiece has taken over the mailpiece. Instead, it is essentially up to the participants 106, 106i, 106′i, 106″i of the delivery service themselves to determine a delivery route leading from the depot 103i where the mailpiece is being held to the destination address, and to deliver the mailpiece via this delivery route.

In the embodiment, at least some participants 106, 106i, 106′i, 106″i of the delivery service are each associated with a depot 103i, whereby there is preferably at least one associated participant 106, 106i, 106′i, 106″i for the depot 103i in the region 102. The association can be made in the manner already described above on the basis of stored routes of the participants 106, 106i, 106′i, 106″i, whereby the depots 103i that are located on or within a predefined area around his stored route are associated with that participant 106, 106i, 106′i, 106″i. In this embodiment, however, the storage of routes is not absolutely required but rather merely optional. Therefore, an association of a participant 106, 106i, 106′i, 106″i with a depot 103i can also be stored in the server 105 on the basis of information to this effect that the participant provides at the time of his registration. In other words, a participant 106, 106i, 106′i, 106″i can register with the delivery service for one or more depots 103i that he has indicated. In order to initiate the transport of the mailpiece that is being held at a given depot 103i, the server 105 sends request messages to the participants 106, 106i, 106′i, 106″i who are associated with this depot 103i. The messages each contain a request as to whether the addressed participant 106, 106i, 106′i, 106″i is willing to take over the mailpiece at the depot 103i. Preferably, the destination address of the mailpiece is also specified in the request message. From among the participants 106, 106i, 106′i, 106″i who respond to the request messages with an acceptance message, the server 105 designates a participant 106, 106i, 106′i, 106″i who is supposed to take over the mailpiece at the depot 103i. This can be, for example, the participant 106, 106i, 106′i, 106″i whose acceptance message was the first to be received. By the same token, the participant 106, 106i, 106′i, 106″i can be selected on the basis of other criteria. A confirmation message is sent to the selected participant 106, 106i, 106′i, 106″i who also receives the identifier of the mailpiece

After the confirmation message has been received, the participant 106, 106i, 106′i, 106″i can pick up the mailpiece at the depot 103i. In this process, the identity of the participant 106, 106i, 106′i, 106″i is checked at the depot 103i in the manner already described above, and it is also checked whether this is the participant 106, 106i, 106′i, 106″i who was designated to take over the mailpiece. After this checking procedure has been carried out successfully, the mailpiece is handed over to the participant 106, 106i, 106′i, 106″i. This participant 106, 106i, 106′i, 106″i records the mailpiece identifier and sends it to the server 105. The server 105 can then likewise check whether the mailpiece has been taken over by the correct participant 106, 106i, 106′i, 106″i. Moreover, the server 105 stores the fact that the participant has taken possession of the mailpiece. The participant 106, 106i, 106′i, 106″i himself is now responsible for controlling the further transport of the mailpiece. The participant 106, 106i, 106′i, 106″i can transport the mailpiece to its destination address himself. In this case, he can have the receipt of the mailpiece at the destination address acknowledged in the manner described above, after which the server 105 notes that the participant 106, 106i, 106′i, 106″i has delivered the mailpiece at the destination address. By the same token, however, the participant 106, 106i, 106′i, 106″i can also make use of the option to communicate with other participants 106, 106i, 106′i, 106″i of the delivery service, and to arrange to hand over the mailpiece to this participant 106, 106i, 106′i, 106″i. In the communication, the participants 106, 106i, 106′i, 106″i can reach an agreement on the transfer point and on the transfer time. If participants agree to hand over a mailpiece, this is preferably reported to the server 105, indicating the identities of the participants 106, 106i, 106′i, 106″i involved as well as the identifier of the mailpiece. When the mailpiece is handed over, the identities of the participants 106, 106i, 106′i, 106″i can be ascertained in the manner already described above. Moreover, the mailpiece identifier is recorded and checked by the participant 106, 106i, 106′i, 106″i who takes over the mailpiece.

In this manner, the mailpiece can be handed over multiple times from one participant 106, 106i, 106′i, 106″i of the delivery service to another participant 106, 106i, 106′i, 106″i. In order to ensure that the mailpiece is transported to the destination address in this process, a requirement can be made stating that the mailpiece has to be delivered by the end of a predefined time span after it was taken over at the depot 103i. Here, the participant 106, 106i, 106′i, 106″i in whose possession the mailpiece is at the end of the time span can be obligated to deliver the mailpiece to the destination address within a predefined time span directly, that is to say, without a further transfer to another participant 106, 106i, 106′i, 106″i of the delivery service. For this purpose, the server 105 can send the participant 106, 106i, 106′i, 106″i a demand to this effect if, by the end of the time span, there has been no registration indicating that the mailpiece has been delivered. Since the delivery service is limited to the delivery of the mailpiece on the so-called “last mile”, the participants 106, 106i, 106′i, 106″i of the delivery service who have taken over a mailpiece are generally so close to the destination address that a direct delivery is a reasonable demand and can be carried out without any further difficulty.

In order to control the transfer of a mailpiece from one participant 106, 106i, 106′i, 106″i to another participant 106, 106i, 106′i, 106″i of the delivery service, the server 105 preferably provides functions that simplify the determination of suitable participants 106, 106i, 106′i, 106″i for handing over a mailpiece. Thus, a participant 106, 106i, 106′i, 106″i who has taken over a mailpiece at the depot 103i or from another participant 106, 106i, 106′i, 106″i can send a request to the server 105 asking for possible participants 106, 106i, 106′i, 106″i to take over the mailpiece. On the basis of such a request, the server 105 selects suitable participants 106, 106i, 106′i, 106″i and informs the requesting participant 106, 106i, 106′i, 106″i about the selection. In this process, the user names of the selected participants 106, 106i, 106′i, 106″i can be sent in a response message to the requesting participant 106, 106i, 106′i, 106″i. Then, on the basis of the user names, he can use the communication platform provided by the server 105 to make contact with one or more of these participants 106, 106i, 106′i, 106″i in order to reach an agreement about taking over the mailpiece.

If a route is stored in the server 105 for the requesting participant 106, 106i, 106′i, 106″i, it can be provided that, on the basis of the request, the server 105 selects those participants 106, 106i, 106′i, 106″i for whom a route is stored that intersects the participant route or that runs in a predefined area around the participant route. When the requesting participant 106, 106i, 106′i, I 06″i is informed about the selection, for each of the selected participants 106, 106i, 106′i, 106″i, the determined intersecting point or the point with the smallest distance between the routes can also be indicated by the server 105, since this is a potential transfer point. Consequently, in the contact with the other participant 106, 106i, 106′i, 106″i and the communication held between the participants 106, 106i, 106′i, 106″i, a transfer point that is convenient for both participants 106, 106i, 106′i, 106″i can already be suggested or agreed upon for handing over the mailpiece. In another embodiment, the selection can be limited to those participants 106, 106i, 106′i, 106″i whose routes intersect the participant route of the requesting participant 106, 106i, 106′i, 106″i or that run in a predefined area around this route, and that are, at least in sections, closer to the destination address of the mailpiece than the route of the requesting participant 106, 106i, 106′i, 106″i is. On the basis of such a selection, the requesting participant 106, 106i, 106′i, 106″i is informed about the other participants 106, 106i, 106′i, 106″i who can take over the mailpiece on their route and who could possibly transport the mailpiece closer to the destination address on their routes.

In another embodiment, it can be provided that the server 105 ascertains the position of the requesting participant 106, 106i, 106′i, 106″i or that the position is reported to the server 105 in the manner already described above. On the basis of this position, the server 105 determines additional participants 106, 106i, 106′i, 106″i of the delivery service who are present within a circle having a predefined radius around the position of the requesting participant 106, 106i, 106′i, 106″i, and it informs the requesting participant 106, 106i, 106′i, 106″i about the additional participants 106, 106i, 106′i, 106″i who have been selected in this manner. The requesting participant 106, 106i, 106′i, 106″i can then contact these participants 106, 106i, 106′i, 106″i via the communication platform in order to possibly agree upon handing over the mailpiece. In order to be able to make such a selection, the position of the participants 106, 106i, 106′i, 106″i is tracked by the server 105. This can be done, for example, in that the participants 106, 106i, 106′i, 106″i report their position to the server 105 at regular intervals. The regular position reporting can preferably be activated and deactivated by the participants 106, 106i, 106′i, 106″i. An activation can be carried out by a participant 106, 106i, 106′i, 106″i if he is available to take over mailpieces. If this is not the case, the participant 106, 106i, 106′i, 106″i can deactivate the position reporting.

Participants 106, 106i, 106′i, 106″i whose current position is not known in the server 105 are not taken into consideration for taking over the mailpiece when the server 105 is determining suitable participants 106, 106i, 106′i, 106″i.

In the manner described above, a delivery service is created in that the participants 106, 106i, 106′i, 106″i of the delivery service organize the delivery of mailpieces on the last mile independently so to speak. In this process, an interaction of the type that occurs in social networks is made possible between participants 106, 106i, 106′i, 106″i. In particular, the possibility for such an interaction can motivate participants 106, 106i, 106′i, 106″i to take part in the envisaged delivery service. The recipient sets the remuneration for the transport of the mailpiece within limits defined by the server 105. If the delivery route is divided into partial segments, the remuneration is divided up accordingly among the partial segments. In this context, various alternatives for the organization of the division and the corresponding remuneration are conceivable. Thus, the route can be divided up, for example, by the participant 106, 106i, 106′i, 106″i who transports the mailpiece over the first partial segment in that he selects the subsequent participant. For this purpose, he can gain access to the server 105 and obtain information about possible subsequent participants. He can make contact with these possible subsequent participants and, on his part, he can make an offer for remuneration for them to transport the mailpiece over the partial segment in question. If the second partial segment has to be divided up further, then this can likewise be organized by the participant 106, 106i, 106′i, 106″i who has taken care of the first partial segment. The participant 106, 106i, 106′i, 106″i who takes care of the second partial segment, however, can also look for the subsequent participant in the same manner as the participant 106, 106i, 106′i, 106″i who had taken care of the first partial segment had already done. In this manner, any desired number of partial segments can be arranged consecutively until the entire delivery route has been taken care of by one or by any desired number of participants 106, 106i, 106′i, 106″i. As an alternative, however, it is also conceivable for the operator of the server 105 to take over the organization of partial segments. This can be done in the same manner as was described for the case in which the entire delivery route is handled by just one participant 106, 106i, 106′i, 106″i. Moreover, the recipient can also take over the organization of the partial segments. For example, it is possible that the recipient does not find a participant 106, 106i, 106′i, 106″i who is willing to handle the entire delivery route. The recipient can likewise be given access to the server 105 and can obtain the information from it as to which partial segments can be handled by participants 106, 106i, 106′i, 106″i. Accordingly, he can offer certain partial segments that need to be taken care of, whereby he can offer appropriate remunerations for the transport. For this purpose, he can be offered assistance from the server 105 in which remuneration ranges for each partial segment are suggested. The remuneration ranges can be calculated by the server 105 as a function of the segment in question, as a function of the volume of the mailpiece and/or of the weight of the mailpiece and/or of the transport time frame. Moreover, any combinations of the proposed alternatives are also conceivable and are encompassed by the invention.

Although the invention was described in detail in the drawings and in the presentation above, the presentations are illustrative and are provided by way of an example, but are not to be construed as being of a limiting nature. In particular, the invention is not restricted to the elucidated embodiments. The person skilled in the art can glean additional variants of the invention and its execution from the preceding disclosure, from the figures and from the patent claims.

In the patent claims, terms such as “encompass”, “comprise”, “contain”, “have” and the like do not exclude additional elements or steps. The use of the indefinite article does not preclude the plural. Each individual device can execute the functions of several of the units or devices cited in the patent claims. The reference numerals indicated in the patent claims are not to be construed as a limitation of the means and steps employed.

### LIST OF REFERENCE NUMERALS

101 distribution center
102 region associated with the distribution center
103i, 103i′, 103i″ depot (i=a,b,c)
104i computer unit (i=a,b,c)
105 central server
106, 106i, 106′i, 106″i participant
107 communication terminal device
108 communication network
302, 401 destination address

1. A method for delivering a mailpiece to a destination address, whereby
the mailpiece is held at one depot of a plurality of depots, at least one first participant of a service is selected from a plurality of participants registered for the service on the basis of an association of the participant with that depot,
the recipient of the mailpiece uses a communication terminal device to indicate a price he is willing to pay for the delivery, whereby this price and a request are transmitted to the at least one selected first participant of the service,
an acceptance message from the at least one first participant sent in response to the request is received, and whereby the mailpiece is handed over to the first participant at the depot on the basis of the receipt of the acceptance message for the transport over at least a partial segment of a delivery route to the destination address.

2. The method according to claim 1, whereby a route is stored for each of the participants of the service and the at least one first participant is selected on the basis of an evaluation of the stored routes of the participants, and whereby the evaluation is carried out as a function of the location of the depot and/or of the destination address.

3. The method according to claim 1, whereby, on the basis of the routes stored for the participants, at least one additional participant is selected to transport the mailpiece over another partial segment of the delivery route, and whereby a transfer point for handing over the mailpiece to the additional participant is determined.

4. The method according to claim 3, whereby a notification is sent to the additional participant on the basis of the selection of the additional participant, and whereby the mailpiece is transferred at the transfer point on the basis of an acceptance message sent by the additional participant in response to the request.

5. The method according to claim 3, whereby, when the mailpiece is handed over to the additional participant, the identity of at least one of the participants involved in the transfer and/or the identity of the mailpiece is checked, and whereby the checking procedure is carried out especially with the cooperation of one of the participants involved.

6. The method according to claim 5, whereby the checking procedure is carried out by means of a communication terminal device of the cooperating participant, identification data pertaining to the mailpiece and/or to the other involved participant is acquired, and whereby, in order to check the identification data, information is used that is made available by a server that can be connected to the communication terminal device via a communication network.

7. The method according to claim 2, whereby, in order to transport the mailpiece over at least one partial segment of the delivery route, one or more participants for whom routes are stored that run within a predefined area surrounding the depot and/or the destination address are selected on the basis of the evaluation.

8. The method according to claim 1, whereby the partial segments of the delivery route are determined on the basis of sections of the routes stored for the participants in such a way that the delivery route meets at least one optimization criterion, and request messages are sent to the participants who are associated with stored routes that are at least partially comprised in the determined delivery route.

9. The method according to claim 8, whereby the delivery route is determined anew if acceptance messages are not received in response to all of the request messages within a predefined period of time, and whereby, when the delivery route is determined anew, the routes of the participants from whom no acceptance message was received within the period of time are not taken into consideration.

10. The method according to claim 1, whereby, for at least a partial segment, a request message is sent to a plurality of participants and a participant from whom an acceptance message has been received is selected to transport the mailpiece over the partial segment.

11. The method according to claim 1, whereby a server provides a communication platform that is configured to establish communication between a recipient and at least one additional participant of the service.

12. The method according to claim 11, whereby the server is configured to transmit a price indicated by the recipient to the at least one first participant of the service as an offer for the delivery, whereby the acceptance of the offer can be transmitted to the server by the at least one first participant.

13. The method according to claim 11, whereby the server communicates with a communication terminal device, and the recipient of the mailpiece uses a communication terminal device to indicate a price he is willing to pay for the delivery and he sets this on a slider.

14. A system for transporting a mailpiece to a destination address, comprising at least one depot of a plurality of depots for holding mailpieces, and comprising a server, which is configured to select at least one first participant of a service from a plurality of participants registered for the service on the basis of an association of the participant with the depot,
to send a request to the selected first participant, and to receive an acceptance message from the participant sent in response to the request, whereby
the mailpiece can be handed over to the first participant on the basis of the receipt of the acceptance message for the transport over at least a partial segment of a delivery route to the destination address.
